(19) United States
(12) Patent Application Publication
(10) Pub. No.: US 2021/0192447 A1
(43) Pub. Date: Jun. 24, 2021

(54) REAL-TIME COLLECTION AND COMMUNICATION OF QUARRY SCALE TICKET INFORMATION

(71) Applicant: Caterpillar Inc., Peoria, IL (US)

(72) Inventors: Gautham Subramanian, Peoria, IL (US); Chad T. Brickner, Dunlap, IL (US)

(73) Assignee: Caterpillar Inc., Peoria, IL (US)

(21) Appl. No.: 16/725,962

(22) Filed: Dec. 23, 2019

(51) Int. Cl. G06Q 10/08; G01G 19/02; G06Q 50/28; G06Q 50/02

(52) U.S. Cl. CPC G06Q 10/0835; G06Q 50/02; G06Q 50/28; G01G 19/021

(57) ABSTRACT

A system and method for a scale ticketing system includes a scale computer and a hardware device. The scale computer is configured to issue a command with associated data that includes the ticket information to generate a scale ticket for a truck positioned at a scale associated with the scale ticketing system. The hardware device is connected to the scale computer and configured to identify the command and extract the ticket information from the associated data in response to identifying the command. The hardware device is also configured to transmit the extracted ticket information to a remote computing device.

### TECHNICAL FIELD

The present application relates generally to quarry sites. More particularly, the present application relates to real-time collection and provision of scale ticket information for outbound trucks at quarry sites.

### BACKGROUND

At a quarry worksite, trucks arrive, are loaded with material, and are dispatched to a customer. When a truck is loaded and ready to leave the quarry, the truck is weighed, and a ticket is printed that specifies the weight and other information (material, contract details, etc.). The truck driver is provided with the printed ticket and delivers the ticket to the customer along with the hauled material. Thus, the customer receives the printed ticket at the same time as the material is received. If something unexpected occurred at the quarry site with respect to the truck or the material, the customer often does not learn of this information until the truck has arrived.

US 20190181917 A1 teaches a system that uses radio frequency identification (RFID) to track coal mining operations.

### SUMMARY OF THE INVENTION

In one example, a method of collecting ticket information from a scale computer includes identifying, by a hardware device connected to the scale computer, a command received from the scale computer for generating a scale ticket for a respective truck hauling a material; extracting, by the hardware device, ticket information from data sent from the scale computer and associated with the command, the extracted ticket information including one or more properties with respect to the truck hauling the material; and transmitting the extracted ticket information from the hardware device to one or more remote computing systems.

In another example, a scale ticketing system includes a scale computer and a hardware device. The scale computer is configured to issue a command with associated data that includes the ticket information to generate a scale ticket for a truck positioned at a scale associated with the scale ticketing system. The hardware device is connected to the scale computer and configured to identify the command and extract the ticket information from the associated data in response to identifying the command. The hardware device is also configured to transmit the extracted ticket information to a remote computing device.

In another example, a method includes detecting, by a hardware device connected to a scale computer, a command for generating a ticket for a respective truck hauling a material from a quarry site; determining, by the hardware device, ticket information from data sent from the scale computer and associated with the command, the extracted ticket information including one or more properties with respect to the truck and the material; and transmitting the extracted ticket information from the hardware device to a remote server.

### BRIEF DESCRIPTION OF THE DRAWINGS

FIG. 1 is a flowchart illustrating a method of collecting and providing scale ticket information regarding an outbound truck at a quarry site.

FIG. 2 is a diagram illustrating logical connections between a backend engine and various entities.

FIGS. 3A-3D are flowcharts illustrating methods of using scale ticket information obtained in real-time by the various entities from the backend engine.

FIG. 4 is a system diagram illustrating a system for automatically obtaining and providing scale ticket information for an outbound truck at a quarry site.

### DETAILED DESCRIPTION

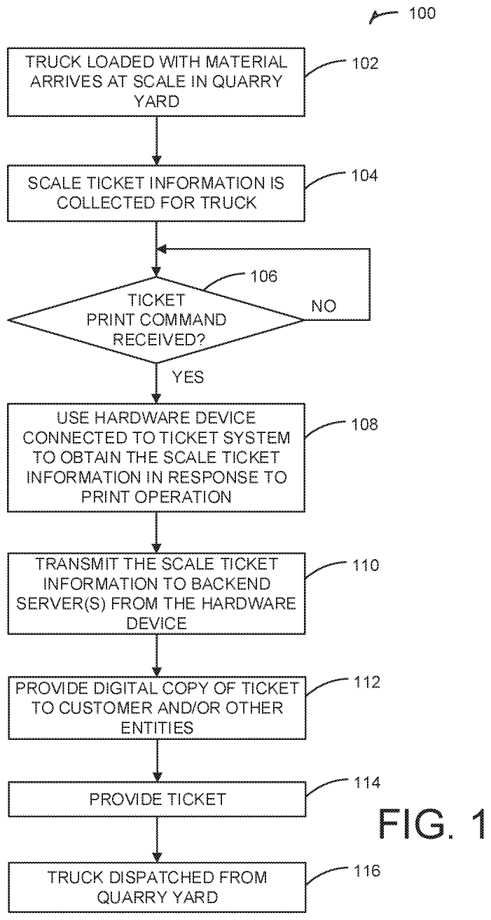

FIG. 1 is a flowchart illustrating a method 100 of automatically collecting and providing ticket information regarding an outbound truck at a quarry site or other material loading/construction site. By collecting and providing the ticket information to a backend engine, for example, a customer and/or other entities can be provided with the scale ticket information in real-time, providing the customer with data indicative of events that occurred at the quarry site, allowing the customer to act earlier than would have otherwise been possible.

Trucks arrive at a quarry site, are loaded with a desired amount of material, and are dispatched from the quarry site to transport the material to a customer's work site, for example. At step 102, a truck has arrived at the quarry site, is loaded with material, and arrives at a scale in a quarry site to be weighed and dispatched from the quarry site. This may be one of several trucks currently located at the quarry site. The quarry may include any material such as stone, sand, gravel, slate, coal, granite, asphalt, and the like.

At step 104, scale ticket information is collected for the outbound truck. This information may include the weight measured by the scale, the customer, contract details, the time the truck arrived at the quarry site, the current time, a driver of the truck, and the like. This information may be collected automatically by the scale and/or input by a quarry site operator. For example, the scale may be connected to a computer system that includes a printer and one or more input/output (IO) devices. The computer system may collect the weight of the truck directly from the scale and customer details from a site operator through an IO device. The computer system may also include an IO device, such as a button, touchscreen, or the like, selectable by the truck driver and/or the quarry site operator for printing, providing, or otherwise displaying a ticket that includes the scale ticket information.

Method 100 stays at step 106 until the truck driver or the quarry site operator provides an input to print or otherwise provide the scale ticket. In an example, the scale computer system provides a print command and associated data to the scale printer to print the scale ticket for the driver. At step 108, a hardware device connected to the scale computer detects the print command generated in response to the truck driver or site operator requesting a ticket. The print command may be generated by the scale computer system and provided to the scale ticket printer or hardware device in any format. In one example, the scale printer is connected to the scale computer through the hardware device. For example, the hardware device receives an input from the scale computer through a parallel or serial port and provides an output to the scale printer through another parallel or serial port. In another example, the hardware device is connected to the scale computer separately from the scale printer but still receives the print command and associated data.

When the hardware device identifies the print command, the hardware device extracts the scale ticket information from the data sent to the scale printer for printing of the ticket. In one example, the hardware device is connected between the scale printer and the scale computer system in which case all commands for the scale printer go through the hardware device. In another example, the hardware device may be connected to the scale computer system separately from the printer with printer commands being received both by the scale printer and the hardware device. The data sent from the scale computer system may be in any format. For example, the print command may be followed by one or more data frames that include several data fields, each providing a different value for printing by the scale printer. The hardware device knows the data format and extracts the ticket information from the data sent to the printer. This data may include load size/weight, customer, contract details, quarry arrival time, quarry departure time, material type, material quality, truck driver, and the like. In some examples, the hardware device may identify a format from one of several known predetermined formats. For example, different types of scale computers may package data in different formats. The hardware device may be compatible with several different formats or be configured for a respective format when installing with a respective scale computer system.

At step 110, the hardware device transmits the scale ticket information to one or more servers or other computing devices. The hardware device may include a wireless transmission device capable of wireless communication of data over one or more wireless networks. For example, the hardware device may connect to a Wi-Fie network, a cellular network, or any other wireless network. In another example, the hardware device may transmit the data over a wired connection. For example, the hardware device may include an Ethernet connector configured to provide connection to a local area network (LAN). The one or more servers may implement a backend engine, for example, capable of packaging the scale ticket information and transmitting the information to one or more entities including customer servers, quarry management servers, transportation entity servers, supplier servers, and the like.

At step 112, the backend engine provides a digital copy of the scale ticket to the customer associated with the material haul. This may be packaged in any data format to include properties of the haul such as the load size/weight, customer, contract details, quarry arrival time, quarry departure time, truck driver, material type, material quality, and the like. In addition to the customer, the information can also be transmitted to other entities such as a transportation entity, quarry manager, supplier, and the like. At step 114, a ticket is provided to the truck driver with the scale ticket information. This may be a printed ticket using a scale printer, a ticket displayed through a display device connected to the scale computer system, a ticket attached and emailed to the truck driver in any format, and the like. At step 116, the truck is dispatched from the quarry.

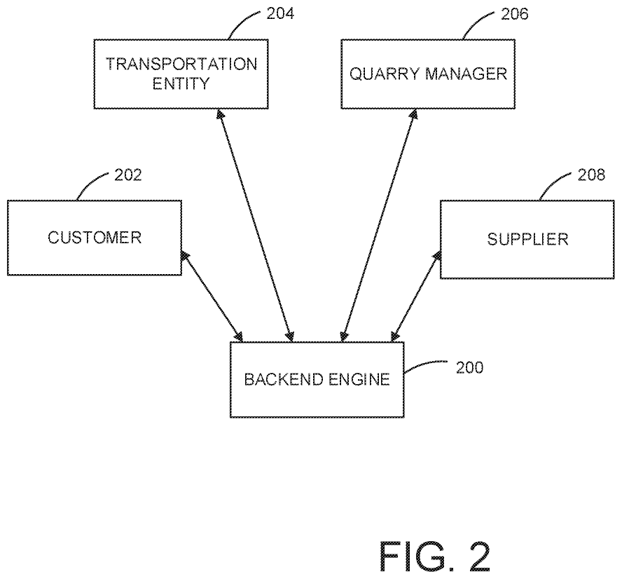

FIG. 2 is a diagram illustrating connections between a backend engine 200 and various entities. The backend engine 200 may be implemented by one or more servers or other computing devices through hardware and/or software to provide one or more services for one or more entities. As described above with respect to step 112 of FIG. 1, the backend engine 200 receives ticketing information from a ticketing system. The backend engine 200 may also be configured to receive data from one or more other sources. For example, the backend engine 200 may also receive data indicating arrival times of respective trucks from a system separate from the quarry scale computer.

The backend engine 200 may be implemented and connected to communicate data to, or otherwise provide a service for, a customer 202, a transportation entity 204, a quarry manager 206, and a supplier 208. While illustrated as four connections in FIG. 2, the backend engine 200 may be connected to any other entities. The customer 202, transportation entity 204, quarry manager 206, and supplier 208 may each include systems implemented on one or more servers or other computing systems operated by those entities. In another example, the backend engine 200 may be implemented as a web-service in which each of the customer 202, the transportation entity 204, quarry manager 206, and/or supplier 208 have an account with the web-service and are able to login to the web service to access data.

The backend engine 200 may transmit the data received from the scale computing system to each of the customer 202, the transportation entity 204, the quarry manager 206, and/or the supplier 208 in real-time. Real-time may be defined as concurrently, or within a threshold amount of time, of a respective event such as a ticket request. The customer 202 may be the consumer of the material being hauled by the dispatched truck. The transportation entity 204 may be a company or other entity that owns the dispatched truck, manages a fleet that includes the dispatched truck, and/or employs the driver of the dispatched truck. The quarry manager may be the on-site manager or management company of the quarry site, and the supplier may be the supplier of the material at the quarry site. The data may be provided to the entities in the same format as was received by the backend engine 200. In another example, the data may be repackaged by the backend engine 200 prior to transmission to the entity. This may be advantageous if specific entities want specific details regarding dispatched trucks. The backend engine 200 can provide customized data to each respective customer regarding material hauls.

The backend engine 200 may also implement one or more databases for storing data received from the scale ticketing computer and other sources. The databases may store this data for each respective customer 202, transportation entity 204, quarry manager 206, supplier 208, and/or other entities. This data can be compiled and provided to the entities at any desirable time. The backend engine 200 may also be configured to coordinate actions between the customer 202, the transportation entity 204, the quarry manager 206, and the supplier 208 using the received and/or stored data.

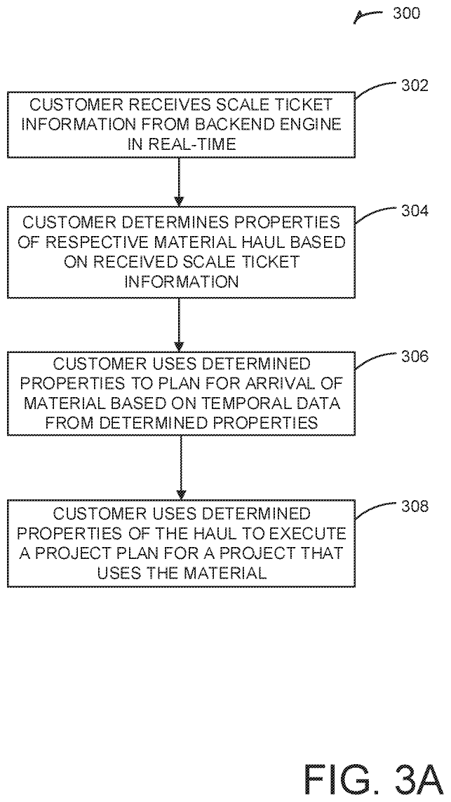

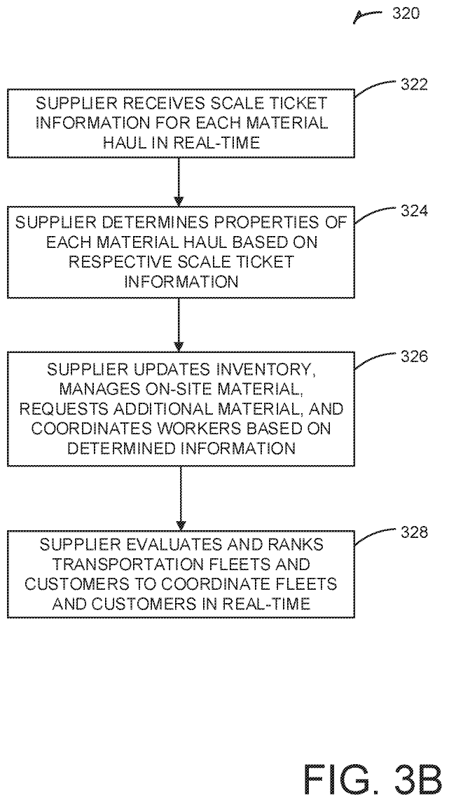

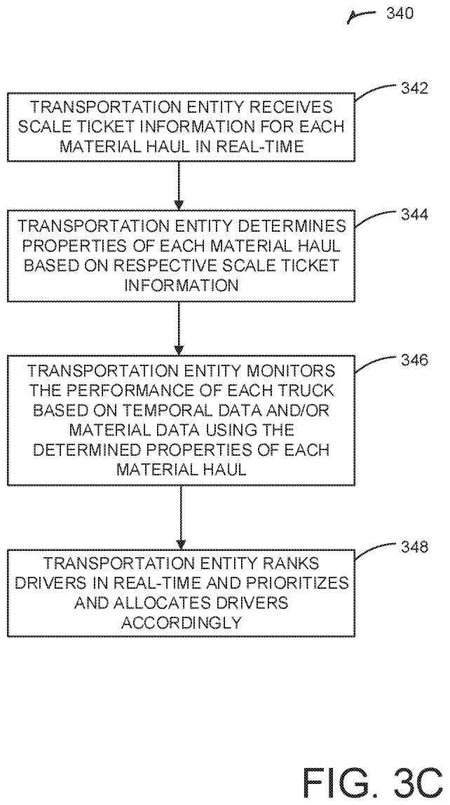

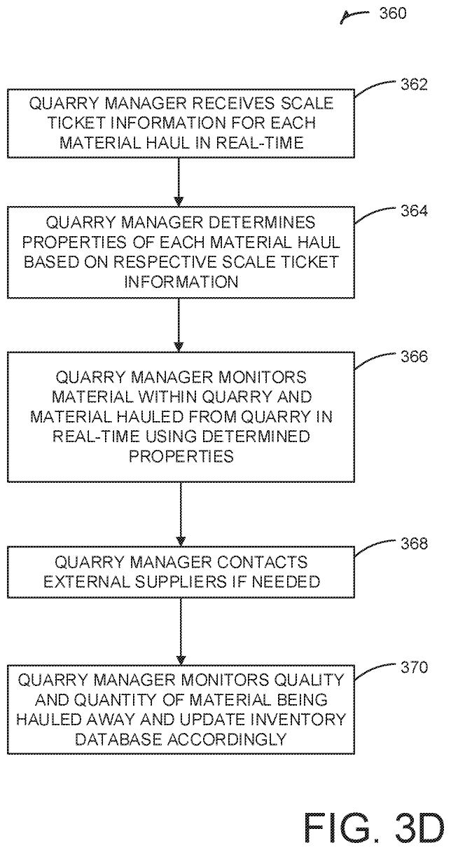

FIGS. 3A-3D are flowcharts illustrating methods of using scale ticket information obtained in real-time for the various entities. By receiving scale ticket information in real-time, each entity can plan and take action with respect to hauled material more quickly than with conventional ticketing methods. For example, with paper tickets, a customer must wait until the driver arrives at a respective construction site and provides the printed paper ticket to the customer to learn the details of a respective material haul. FIG. 3A is a flowchart illustrating a method 300 of using scale ticket information for a customer of the material. At step 302, the customer 202 receives scale ticket information from the backend engine 200 in real-time with respect to a truck dispatching from the quarry site. At step 304, the customer 202 determines the properties of the respective material haul from the received scale ticket information. In an example, the material haul may be 20 tons of stone. The customer 202 can then, in real-time, determine that a truck has dispatched with the 20 tons of stone at a respective time.

At step 306, the customer 202 can use the determined properties to plan for the arrival of the material based on temporal data from the determined properties. In an example, the data may indicate that the truck has dispatched from the site much earlier or later than expected. For example, the customer 202 may have expected the truck to dispatch at 1:00 pm, with the truck actually dispatching at 3:30 pm. The customer 202 may change plans at the work site based on this data in order to optimize workforce. For example, if workers have not yet arrived at the site, the customer 202 may inform the workers that the truck is delayed, allowing the workers to arrive at a time closer to when the material will arrive, which may save resources, optimize labor, busy-ness, and the like.

At step 308, the customer 202 uses the determined properties of the material haul to execute or adjust a project plan for one or more projects that use the material. For example, the customer 202 may rent dozers or other construction machines for compacting the soil and assign subzones where stone is to be placed. The customer 202 may also plan workforce to optimize use of rental equipment to have two/three shifts of workers beginning when the material arrives. By obtaining the scale ticket data in real-time, the customer 202 can better plan for the dispatched material, improving the quality and efficiency of project execution. While described with respect to the customer 202, the method 300 may be performed by one or more computing systems or servers implemented by the customer 202.

FIG. 3B is a flowchart illustrating a method 320 of using scale ticket information for a supplier 208 of the material. At step 322, the supplier 208 receives scale ticket information for a respective truck hauling material in real-time. At step 324, the supplier 208 determines the properties of the respective material haul from the received scale ticket information. These properties may include the amount of material, the quality of material, the time of dispatch, and the like. In an example, the material haul may be 15 tons of granite. The supplier can, in real-time, determine that a truck has dispatched with the 15 tons of granite, and the quality of the granite.

At step 326, the supplier 208 updates inventory, manages on-site material, requests additional material, and coordinates workers in real-time based on the determined properties from the scale ticket information. The supplier 208 may use additional details already known or obtained from other sources. In an example, the supplier 208 may monitor material and update inventory in a database based on the haul of each dispatched truck. The supplier 208 may then consolidate physical groupings of material at the quarry based on the inventory database. The supplier 208 may also request additional material and plan workforce.

At step 328, the supplier 208 is also able to evaluate transportation fleets and customers 202 based on the determined properties for respective material hauls. For example, the supplier can monitor the performance of a specific transportation fleet based on time of entry, time spent at quarry site, time in transit, and the like. Several of these properties can be obtained in real-time based on the properties obtained from the scale ticket information, for example, his allows the supplier 208 to rank the transportation entity in real-time. Similarly, the supplier can rank/prioritize customers 202 based on factors that include size of delivery, type of material to be delivered, size of material to be delivered, quality of material delivered, and the like. The supplier 208 is then able to coordinate transportation fleets and customers 202 such as by allocating high efficiency fleets to high priority customers. By accomplishing this in real-time, the supplier can better keep high priority customers 202 satisfied. While described with respect to the supplier 208, the method 320 may be performed by one or more computing systems or servers implemented by the supplier 208.

FIG. 3C is a flowchart illustrating a method 340 of using scale ticket information for a transportation entity 204. At step 342, the transportation entity 204 receives scale ticket information for a respective truck hauling material in real-time. The transportation entity 204 may be a company that owns or rents the truck, for example, and/or employs the driver of the truck. At step 344, the transportation entity 204 determines the properties of the respective material haul from the received scale ticket information. These properties may include the amount of material, the type of material, the quality of the material, the time of dispatch, an arrival time of the truck, a driver of the truck, and the like. Thus, the transportation entity 204 can, in real-time, evaluate performance of a driver of the truck based on the determined properties.

At step 346, the transportation entity 204 monitors the performance of a respective truck driver based on the determined properties including time of entry, time spent at the quarry, and the like. The transportation entity 204 may also monitor the performance of the respective truck driver based on the type of material hauled, the quantity of material loaded, the quantity of material delivered, damage incurred by the material while loading, when in transit, and while unloading. Some of these properties may be determined in real-time by the scale ticket information, and some other properties may be obtained from other sources.

At step 348, the transportation entity 204 ranks the drivers and prioritizes and allocates drivers according to the rankings. For example, each driver may be ranked, and the rankings may be updated each time scale ticket information is received. The transportation entity may prioritize truck drivers based on the rankings and allocate high efficiency drivers to high priority customers, for example. By accomplishing this in real-time, the transportation entity 204 can better keep high priority customers satisfied. While described with respect to the transportation entity 204, the method 340 may be performed by one or more computing systems or servers implemented by the transportation entity 204.

FIG. 3D is a flowchart illustrating a method 360 of using scale ticket information by a quarry manager 206. At step 362, the quarry manager 206 receives scale ticket information for a respective truck hauling material in real-time from the backend engine 200, for example. At step 364, the quarry manager 206 determines the properties of the respective material haul from the received scale ticket information. These properties may include the amount of material, the quality of material, the time of dispatch, and the like.

At step 366, quarry manager 206 monitors material within the quarry and material hauled from the quarry in real-time using determined properties. For example, the quarry manager 206 may monitor a type, quantity, and quality of materials hosted at the quarry in real-time (for example, sand, 200 tons, fine sand; asphalt, 300 tons, driveway grade). The quarry manager 206 can monitor, in real-time, the type, quality, and quantity of material being hauled away by each dispatched truck and can identify existing piles of material where the hauled material is located. At step 368, the quarry manager 206 can contact external suppliers if the material demanded is less than the material currently available. At step 370, the quarry manager 206 monitors, in real-time, the type, quality, and quantity of material being hauled away by respective trucks dispatched from the quarry site and updates a material database accordingly. While described with respect to the quarry manager 206, the method 360 may be performed by one or more computing systems or servers implemented by the quarry manager 206.

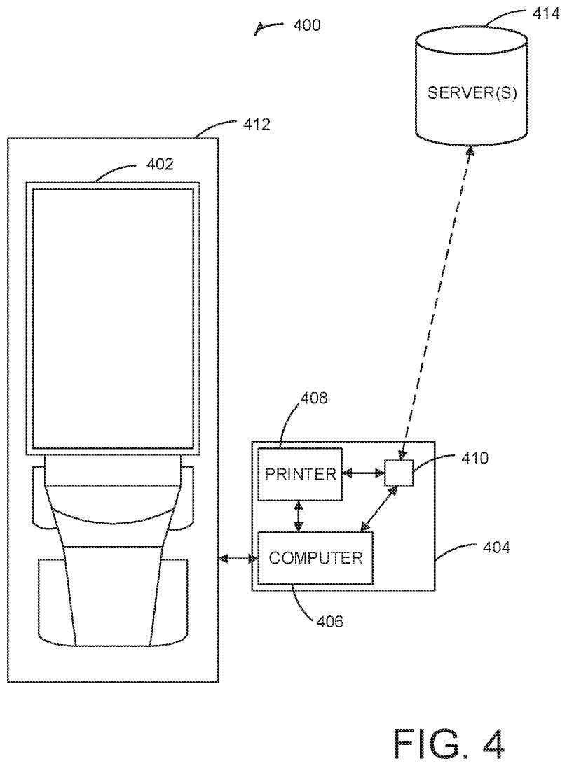

FIG. 4 is a system diagram illustrating a system 400 for automatically obtaining and providing scale ticket information for an outbound truck 402 at a quarry site. The system 400 includes a scale ticketing system 404 that includes a computer system 406, a scale printer 408, and a hardware device 410. Conventional scale ticketing systems may include only the computer system 406 and the scale printer 408 without the hardware device 410. The computer system 406 may be any computer system including one or more controllers, processors, input/output devices, displays, volatile and/or non-volatile memories, peripheral devices, and/or any other computer components. The scale printer 408 may be a general-purpose printer, or a printer designed specifically for printing scale tickets. In another example, the scale printer 408 may be a logical printer implemented by the computer system 406 such as a portable document format (PDF) printer configured to generate a document with the ticket information in PDF or other format. The computer system 406 may be implemented to receive data from a scale 412 configured to weigh the truck 402.

The hardware device 410 is added to the scale ticketing system 404 and is configured to communicate with one or more servers 414 or other computing devices. The hardware device 410 may be connected between the computer system 406 and the scale printer 408 or may be connected to the computer system 406 separately from the scale printer 408.

The hardware device 410 can include, for example, software, hardware, and combinations of hardware and software configured to execute several functions related to the extraction of scale ticket information based on monitored print data generated by the computer system 406. The hardware device 410 can include an analog, digital, or combination analog and digital controller including a number of components. As examples, the hardware device 410 can include integrated circuit boards or ICB(s), printed circuit boards PCB(s), processor(s), data storage devices, switches, relays, or any other components. Examples of processors can include any one or more of a microprocessor, a controller, a digital signal processor (DSP), an application specific integrated circuit (ASIC), a field-programmable gate array (FPGA), or equivalent discrete or integrated logic circuitry.

The hardware device 410 may include storage media to store and/or retrieve data or other information such as, for example, data received from the computer system 406. Storage devices, in some examples, are described as a computer-readable storage medium. The storage devices, for example, are used by software, applications, algorithms, as examples, running on and/or executed by the hardware device 410. The storage devices can include short-term and/or long-term memory and can be volatile and/or non-volatile. Examples of non-volatile storage elements include magnetic hard discs, optical discs, floppy discs, flash memories, or forms of electrically programmable memories (EPROM) or electrically erasable and programmable (EEPROM) memories. Examples of volatile memories include random access memories (RAM), dynamic random-access memories (DRAM), static random-access memories (SRAM), and other forms of volatile memories.

The hardware device 410 may also include one or more connectors for connecting to the computer system 406 and/or the scale printer 408. For example, the hardware device 410 may include one or more parallel ports, serial ports, universal serial bus (USB) ports, and the like. For example, the hardware device 410 may connect to the computer system 406 through an input parallel port and may connect to the scale printer 408 through an output parallel port.

The hardware device 410 may also include one or more network interfaces. For example, the hardware device 410 may include a wireless network interface and/or wired network interface for connecting to one or more types of network including a local area network (LAN), a wide area network (WAN), a packet data network (e.g., the Internet), mobile telephone networks (e.g., cellular networks), wireless data networks (e.g., Institute of Electrical and Electronics Engineers (IEEE) 802.11 family of standards known as Wi-Fi®), and the like. The one or more network interfaces may be used to communicate data to the servers 414, for example.

The servers 414 may be implemented using any suitable computing devices. In one example, the servers 414 may be configured to implement the backend engine 200. Thus, the servers 414 may be configured to communicate data to one or more entities including customers, transportation entities, material suppliers, quarry managers, and the like.

Hardware device 410 may be configured to identify printing commands generated by the computer system 406 for the scale printer 408. Once the hardware device 410 identifies the print command, the hardware device 410 obtains the data related to the print command provided by the computer system 406 for printing the ticket. The hardware device 410 knows the format of this data and is able to extract the scale ticket information from the data. Once the hardware device 410 had extracted the data, the hardware device 410 transmits the data to the servers 414 in real-time. This may occur before or during printing of the physical ticket by the scale printer 408. The hardware device 410 also passes through or otherwise transmits the print command and the data to the scale printer 408 so that the scale printer 408 prints the physical ticket, which is then provided to a driver of the truck 402 and the truck 402 is dispatched from the quarry site.

In another example, the scale ticketing system 404 may not include a scale printer 408 and the hardware device 410 may act as the scale printer. For example, the hardware device 410 may be connected as a printer to the computer system 406 to receive commands and associated data from the computer system 406. When a ticket is requested, a command with associated data is provided to the hardware device 410, which receives the ticketing information and transmits the ticketing information to the servers 414. By adding the hardware device 410 to the scale ticketing system 404, the customer and/or other entities receive scale ticketing information in real-time, allowing the customer and other entities to improve planning and efficiency as described above with respect to FIGS. 3A-3D.

While described with respect to a quarry site, those skilled in the art will understand that the systems and methods disclosed herein may apply to any material loading site or other construction site.

### INDUSTRIAL APPLICABILITY

In one illustrative example, the hardware device is a Caterpillar® G6M7 device installed at a quarry site scale ticketing system. The G6M7 device may be connected between the scale computer and the scale printer using input and output parallel ports, for example. When a truck arrives at the scale and requests a ticket, the G6M7 device identifies the print command from the scale computer. The scale computer provides the ticket information to the scale printer. The ticket information includes the load weight, the material type, the material quality, contract details, a current time, a check-in time of the truck, a driver of the truck, and a customer to receive the material. The G6M7 device is configured to receive the data from the scale computer on the way to the scale printer and extract the ticket information from the data. The G6M7 device then transmits the ticket information to a Caterpillar® back office.

The back office, which implements a backend engine, collects and compiles the ticket information, linking the dispatching truck to the customer. The backend engine then provides the ticket information to the customer in real-time. The backend engine may also provide the ticket information to the respective quarry manager, material supplier, and transportation fleet. The customer, quarry manager, material supplier, and transportation fleet receive the information and act accordingly. For example, the customer can use the load size, material type, material quality, and dispatch time to better plan for the arrival of the material. The customer can initiate these actions prior to arrival of the dispatched truck, whereas in conventional systems, the customer needed to wait for the dispatched material to arrive to receive the printed ticket. This required the customer to guess as to the time of arrival of the dispatched material, leading to inefficiencies in the event that the loading and dispatch of material did not go exactly as planned.

The above detailed description is intended to be illustrative, and not restrictive. The scope of the disclosure should, therefore, be determined with references to the appended claims, along with the full scope of equivalents to which such claims are entitled.

What is claimed is:

1. A method of collecting ticket information from a scale computer, the method comprising:
identifying, by a hardware device connected to the scale computer, a command received from the scale computer for generating a scale ticket for a respective truck hauling a material;
extracting, by the hardware device, ticket information from data sent from the scale computer and associated with the command, the extracted ticket information including one or more properties with respect to the truck hauling the material; and
transmitting the extracted ticket information from the hardware device to one or more remote computing systems.

2. The method of claim 1, further comprising:
receiving, by a backend engine implemented by the one or more remote computing systems, the extracted ticket information; and
transmitting the extracted ticket information to at least one entity.

3. The method of claim 2, wherein transmitting the extracted information to at least one entity comprises transmitting the extracted information to at least one of: a customer of the material hauled by the truck, a quarry manager of a quarry site, a supplier of the material hauled by the truck, or a transportation entity that coordinates the truck.

4. The method of claim 3, further comprising:
identifying, by the backend engine, the customer of the material hauled by the truck using the extracted ticket information;
wherein transmitting the extracted ticket information comprises transmitting the extracted ticket information to the identified customer.

5. The method of claim 1, wherein extracting the ticket information comprises extracting at least one of a dispatch time, a material type, or a load size of the material hauled by the truck.

6. The method of claim 1, wherein the hardware device is connected between the scale computer and a scale printer, and wherein identifying the command comprises:
receiving the command from the scale computer intended for the scale printer; and
identifying the command from the scale computer as a print command.

7. The method of claim 6, further comprising:
printing, using the scale printer, a physical ticket for a driver of the truck hauling the material in response to receiving the print command.

8. A scale ticketing system comprising:
a scale computer configured to issue a command with associated data that includes the ticket information to generate a scale ticket for a truck positioned at a scale associated with the scale ticketing system; and
a hardware device connected to the scale computer and configured to identify the command and extract the ticket information from the associated data in response to identifying the command;
wherein the hardware device is configured to transmit the extracted ticket information to a remote computing device.

9. The scale ticketing system of claim 8, wherein the remote computing device comprises a backend engine implemented on the remote computing device, and wherein the remote computing device is configured to transmit the extracted ticket information to at least one entity.

10. The scale ticketing system of claim 9, wherein the at least one entity comprises at least one of: a customer of material hauled by the truck, a quarry manager of a quarry site, a supplier of the material hauled by the truck, or a transportation entity that coordinates the truck.

11. The scale ticketing system of claim 8, wherein the ticket information comprises at least one of a dispatch time of the truck, a material type of a material hauled by the truck, or a load size of the material hauled by the truck.

12. The scale ticketing system of claim 8, further comprising:
a scale printer configured to print scale tickets that include the ticket information for the truck positioned at the scale associated with the scale ticketing system;
wherein the hardware device is connected between the scale computer and the scale printer.

13. The scale ticketing system of claim 12, wherein the scale computer is connected to a parallel input port of the hardware device, and wherein the scale printer is connected to a parallel output port of the hardware device.

14. A method comprising:
detecting, by a hardware device connected to a scale computer, a command for generating a ticket for a respective truck hauling a material from a quarry site;
determining, by the hardware device, ticket information from data sent from the scale computer and associated with the command, the extracted ticket information including one or more properties with respect to the truck and the material; and
transmitting the extracted ticket information from the hardware device to a remote server.

15. The method of claim 14, further comprising:
receiving, by a backend engine implemented by the remote server, the extracted ticket information; and
transmitting the extracted ticket information to at least one entity.

16. The method of claim 15, wherein transmitting the extracted information to at least one entity comprises transmitting the extracted information to at least one of a customer of the material hauled by the truck, a quarry manager of the quarry site, a supplier of the material hauled by the truck, or a transportation entity that coordinates the truck.

17. The method of claim 15, further comprising:
identifying, by the backend engine, the customer of the material hauled by the truck using the extracted ticket information; and
wherein transmitting the extracted ticket information comprises transmitting the extracted ticket information to the identified customer.

18. The method of claim 14, wherein determining the ticket information comprises determining at least one of a dispatch time, a material type, or a load size of a material hauled by the truck.

19. The method of claim 14, wherein the hardware device is connected between the scale computer and a scale printer, and wherein identifying the command comprises:
receiving the command from the scale computer intended for the scale printer; and
identifying the command from the scale computer as a print command.

20. The method of claim 19, further comprising:
printing, using the scale printer, a physical ticket for the driver of the truck hauling the material in response to receiving the print command.
